(19) United States
(12) Patent Application Publication
(10) Pub. No.: US 2016/0117728 A1
(43) Pub. Date: Apr. 28, 2016

(54) APPARATUS AND METHOD FOR PROVIDING SEARCH SERVICE AND COMPUTER PROGRAM THEREFOR

(71) Applicant: NAVER Corporation, Seongnam-si (KR)

(72) Inventor: Sang Jun JEON, Seongnam-si (KR)

(21) Appl. No.: 14/877,308

(22) Filed: Oct. 7, 2015

(30) Foreign Application Priority Data
Oct. 22, 2014 (KR) 10-2014-0143589

(51) Int. Cl. G06Q 30/02; G01C 21/36

(52) U.S. Cl. CPC G06Q 30/0256; G01C 21/367; G01C 21/3697; G06Q 30/0273; G06Q 30/0267; G06Q 30/0261

(57) ABSTRACT

A search service providing apparatus including a memory configured to store computer-readable instructions, and one or more processors configured to execute the instructions to receive a search request including input data from a user terminal, the input data including a keyword, generate a search result in response to the input data, the search result including a keyword-related advertisement and a route code corresponding to the keyword-related advertisement, transmit the search result to the user terminal, monitor a user event with regard to the route code, and determine fees to be charged on the keyword-related advertisement, based on the user event may be provided.

### CROSS-REFERENCE TO RELATED APPLICATION

This application claims the benefit of Korean Patent Application No. 10-2014 - 0143589, filed on Oct. 22, 2014, in the Korean Intellectual Property Office, the disclosure of which is incorporated herein in its entirety by reference.

### BACKGROUND

1. Field

One or more example embodiments relate to apparatuses and methods for providing a search service and/or computer programs therefor, and more particularly, to apparatuses and methods for providing a search service including a route code, which is set to provide information regarding a route to a desired (or alternatively, predetermined) location, and/or computer programs therefor.

2. Description of the Related Art

With advancement in wire/wireless communication networks and various interfaces, people routinely searches for information using such a communication network or interface. Users can easily search for and obtain various information via a communication network. Thus, searching for information is greatly affecting every phase of our daily life.

Search sites providing such an information search function have evolved to portals that provide various additional information, various functions, and contents that attract users who visit there. As large-sized portals have become the center of communication life, they have become very influential.

Search sites or portals that provide a search function or portals provide an advertisement service, which enables a user to search an advertisement of interest based on a search keyword that is input by the user to request a search. The advertisement service has become not only one of main sources of income of search sites or portals but also provide a means for effectively providing a user with information regarding companies and/or products corresponding to a specific keyword.

### SUMMARY

Some example embodiments include a search service providing apparatus and method capable of providing a user terminal requesting a search with a route code that is set to provide information regarding a route to a desired (or alternatively, predetermined) location, thereby saving a user's trouble in individually inputting the desired (or alternatively, predetermined) location, and/or a computer program therefor.

Some example embodiments include a search service providing apparatus and method capable of counting a user event of, for example, selecting, sharing, or storing route code and calculating or determining advertisement fees to be charged on an advertiser who registers the route code, based on the user event so that the register may not be charged for merely exposing of the route code and may be charged when the user event of selecting, sharing, or storing the route code occurs. Thus, the fees to be charged on the advertiser may be differentially determined according to a type (e.g., a characteristic and/or a frequency) of the user event, and a computer program therefor.

Additional aspects will be set forth in part in the description which follows and, in part, will be apparent from the description, or may be learned by practice of the presented example embodiments.

According to an example embodiment, a search service providing apparatus includes a memory configured to store computer-readable instructions, and one or more processors configured to execute the instructions to receive a search request including input data from a user terminal, the input data including a keyword, generate a search result in response to the input data, the search result including a keyword-related advertisement and a route code corresponding to the keyword-related advertisement, transmit the search result to the user terminal, monitor a user event with regard to the route code, and determine fees to be charged on the keyword-related advertisement, based on the user event.

In some example embodiments, the route code may be a code configured to provide information regarding a route to a location specified in the keyword-related advertisement.

In some example embodiments, the processor may be configured to execute the instructions to determine the fees, based on at least one of a characteristic and a frequency of the user event.

In some example embodiments, the user event may include at least one of selecting the route code, sharing the route code, and storing the route code, and the processor may be configured to execute the instructions to determine the fees to be charged such that the fees incurred by the user event of selecting the route code is less than the fees incurred by the user event of sharing the route code.

In some example embodiments, the processor may be configured to execute the instructions to determine the fees to be charged on the keyword-related advertisement by taking into account a number of persons with which the route code is shared according to the user event.

In some example embodiments, the user event may include an event of sharing the route code by using at least one of a text message, online chatting, and a social network service.

In some example embodiments, the processor may be further configured to execute the instructions to receive, from a register terminal, an advertisement request to register the keyword-related advertisement and to have the keyword-related advertisement posted based on the search result in response to the input data including the keyword.

In some example embodiments, the route code may be set to be recognized by an external device to cause the external device to display information regarding a route to a location specified in the keyword-related advertisement based on information included in the route code.

According to an example embodiment, a method of providing a search service in a search service providing apparatus, which includes a memory configured to store computer-readable instructions and one or more processors configured to execute the instructions, the method comprising, receiving a search request including input data from a user terminal, the input data including a keyword, generating a search result in response to the input data, the search result including a keyword-related advertisement and route code corresponding to the keyword-related advertisement, transmitting the search result to the user terminal, monitoring a user event with regard to the route code, and determining fees to be charged on the keyword-related advertisement, based on the user event.

In some example embodiments, the route code may be a code configured to provide information regarding a route to a location specified in the keyword-related advertisement.

In some example embodiments, the determining fees may include determining the fees, based on at least one of a characteristic and a frequency of the user event.

In some example embodiments, the user event may include at least one of selecting the route code, sharing the route code, and storing the route code, and the determining fees may include determining the fees to be charged such that the fees incurred by the user event of selecting the route code is less than on the fees incurred by the user event of sharing the route code.

In some example embodiments, the determining fees may include determining the fees to be charged on the keyword-related advertisement by taking into account a number of persons with which the route code is shared according to the user event.

In some example embodiments, the user event may include an event of sharing the route code by using at least one of a text message, online chatting, and a social network service.

In some example embodiments, the method further includes comprising receiving, from a register terminal, an advertisement request to register the keyword-related advertisement and to have the keyword-related advertisement posted based on the search result in response to the input data including the keyword.

In some example embodiments, the route code may be set to be recognized by an external device to cause the external device to display information regarding a route to a location specified in the keyword-related advertisement based on information included in the route code.

In some example embodiments, a non-transitory computer-readable recording media storing computer-readable instructions which cause, when executed by a processor, the processor to perform the aforementioned method may be provided.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram illustrating a structure of a search service providing system according to an example embodiment;

FIG. 2 is a block diagram of a search service providing apparatus according to an example embodiment;

FIG. 3 is a flowchart of a search service providing method according to an example embodiment;

FIGS. 4 and 5 are flowcharts illustrating operations of a search service providing apparatus, a user terminal, and a register terminal according to example embodiments;

FIGS. 6A and 6B illustrate examples of a search result screen including route code provided from a search service providing apparatus according to an example embodiment; and

FIGS. 7A and 7B illustrate examples of a screen displayed on an apparatus that recognizes a route code provided from a search service providing apparatus according to an example embodiment.

### DETAILED DESCRIPTION

Reference will now be made in detail to some example embodiments, examples of which are illustrated in the accompanying drawings, wherein like reference numerals refer to like elements throughout. In this regard, the present example embodiments may have different forms and should not be construed as being limited to the descriptions set forth herein. Accordingly, the example embodiments are merely described below, by referring to the figures, to explain some aspects of the present description. As used herein, the term “and/or” includes any and all combinations of one or more of the associated listed items. Expressions such as “at least one of,” when preceding a list of elements, modify the entire list of elements and do not modify the individual elements of the list.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items. Expressions such as “at least one of,” when preceding a list of elements, modify the entire list of elements and do not modify the individual elements of the list.

It will be understood that although the terms ‘first’, ‘second,’ etc. may be used herein to describe various components, these components should not be limited by these terms. These components are only used to distinguish one component from another. Thus, a first component discussed below could be termed a second element, component without departing from the teachings of example embodiments.

As used herein, the singular forms ‘a’, ‘an’ and ‘the’ are intended to include the plural forms as well, unless the context clearly indicates otherwise.

It will be further understood that the terms ‘comprise’ and/or ‘comprising’ used herein specify the presence of stated features or components, but do not preclude the presence or addition of one or more other features or components.

Meanwhile, when it is possible to implement any example embodiment in any other way, a function or an operation specified in a specific block may be performed differently from a flow specified in a flowchart. For example, two consecutively described processes may be performed substantially at the same time or performed in an order opposite to the described order.

Example embodiments of inventive concepts can be embodied as hardware, software, or combinations of hardware and software. Example embodiments of inventive concepts can also be embodied as computer-readable codes on a computer-readable medium. The computer-readable recording medium is any data storage device that can store data as a program (or program instructions) which can be thereafter read by a computer system. Also, functional programs, codes, and code segments according to example embodiments of inventive concepts can be construed by programmers having ordinary skill in the art to which example embodiments of inventive concepts pertain.

The units and/or modules described herein may be implemented using hardware components and/or software components. For example, the hardware components may include processing devices. A processing device may be implemented using one or more hardware devices configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and/or one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and/or multiple types of processing elements. For example, a processing device may include multiple processors or a processor and a controller. Further, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts.

Hereinafter, some example embodiments will be explained in further detail with reference to the accompanying drawings.

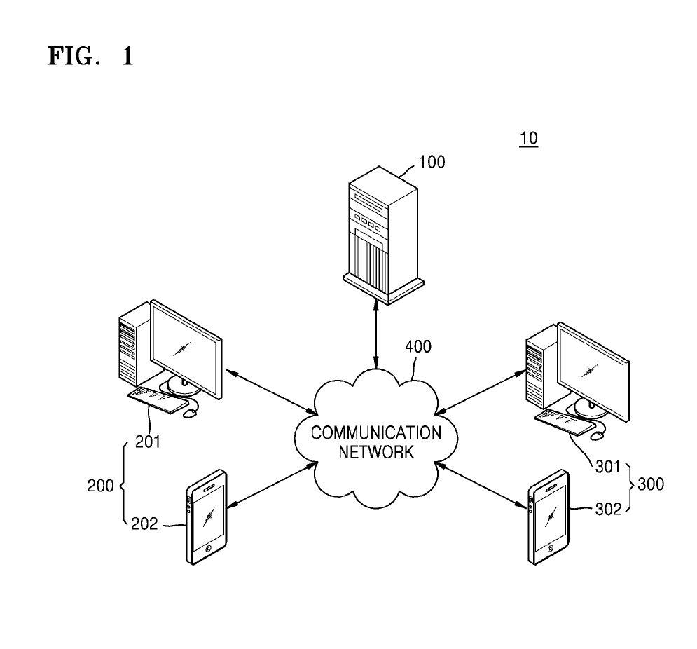

FIG. 1 is a diagram illustrating a structure of a search service providing system 10 according to an example embodiment.

Referring to FIG. 1, a search service providing system 10 according to an example embodiment includes a search service providing apparatus 100, user terminals 200, and register terminals 300.

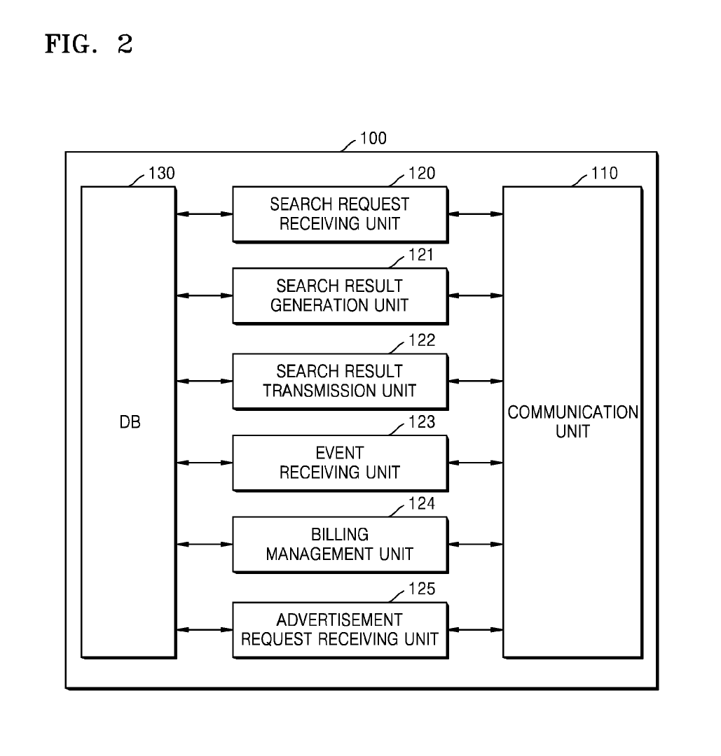

The search service providing system 10 according to an example embodiment receives a search request including input data from the user terminal 200, and provides the user terminal 200 with a search result that includes a keyword-related advertisement corresponding to the input data and that matches the input data. Also, the search service providing system 10 according to an example embodiment provides a keyword-related advertisement corresponding to the input data received from the user terminal 200, together with a route code corresponding to the keyword-related advertisement. Here, the route code means a code that when executed by a processor or a computer, is set to configure the processor or the computer to provide a route to a location related to the keyword-related advertisement. For example, the route code may be identification code such as a barcode or a quick-response (QR) code, as will be described in detail with reference to FIG. 2 below. A user may directly receive information regarding a route to a desired (or alternatively, predetermined) location through the route code provided from the search service providing apparatus 100 according to an example embodiment without having to individually input the desired (or alternatively, predetermined) location.

Further, the search service providing apparatus 100 according to an example embodiment may sense, notice, monitor, or receive a user event of selecting, sharing, or storing the route code and calculate or determine a sum of money (e.g., advertisement fees) to be charged on an advertiser who has registered the route code, taking into account of an advertisement effect of the user event. For example, the search service providing apparatus 100 may charge nothing when a route is merely exposed, and may charge some costs when a subsequent event of selecting, sharing, or storing the route actually is occurred by a user. That is, an advertiser who registers an advertisement with the search service providing apparatus 100 according to an example embodiment may be charged for the advertisement fees when a subsequent event of selecting, sharing, or storing the route is actually occurred by a user. Thus, the advertiser may obtain improved advertisement effect at the same fees.

The search service providing apparatus 100 according to an example embodiment may receive, from the register terminal 300, an advertisement request including, for example, an address of a web site at which an advertisement related to a keyword is to be exposed and a route code.

A user may access the search service providing apparatus 100 via the user terminal 200, transmit a search request, and receive a search result matching input data included in the search request. The user may also select, share, or store the route code included in the search result via the user terminal 200, as will be described in detail with reference to FIG. 2 below.

Here, the user terminal 200 may be, for example, a personal computer (PC) 201 or a portable terminal 202 belonging to a user. The user's portable terminal 202 may be a smart phone, a tablet PC, a smart watch, or any terminal in which an application web having a browsing function is installed. The user terminal 200 may include, for example, a display unit configured to display a screen, and an input device via which data is input from a user. Examples of the input device may include, but are not limited to, a keyboard, a mouse, a track ball, a microphone, a button, a touch panel, etc.

An advertiser who wants to make his or her advertisement searchable may access the search service providing apparatus 100 via the register terminal 300 so as to request an advertisement to be exposed to, for example, the general public. The advertiser may request an advertisement including a route code, which when executed by a processor or a computer, is set to configure the processor or the computer to provide information regarding a route to a desired (or alternatively, predetermined) location, via the register terminal 300.

Here, the register terminal 300 may be, for example, a PC 301 or a portable terminal 302 belonging to a register. The register's portable terminal 302 may be a smart phone, a tablet PC, a smart watch, or any terminal in which an application web having a browsing function is installed. The register terminal 300 may include, for example, a display unit configured to display a screen, and an input device via which data is input from a user. Examples of the input device may include, but are not limited to, a keyboard, a mouse, a track ball, a microphone, a button, a touch panel, etc.

The search service providing apparatus 100, the user terminals 200, and the register terminals 300 of the search service providing system 10 according to an example embodiment may be connected to one another via a wire/wireless communication method using, for example, the Internet, or the like, but are not limited thereto.

A communication network 400 may be configured to connect the user terminals 200, the register terminals 300, and the search service providing apparatus 100 with each other. That is, the communication network 400 refer to a communication network that provides an access route via which the user terminals 200 or the register terminals 300 may access the search service providing apparatus 100 to transmit or receive packet data.

FIG. 2 is a block diagram of a search service providing apparatus 100 according to an example embodiment.

Referring to FIG. 2, the search service providing apparatus 100 may include a communication unit 110, a search request receiving unit 120, a search result generation unit 121, a search result transmission unit 122, an event receiving unit 123, a billing management unit 124, an advertisement request receiving unit 125, and a database 130.

The communication unit 110 may provide a communication interface for providing a signal to be exchanged in a packet data form between the search service providing apparatus 100 and the user terminal 200 and/or between the search service providing apparatus 100 and the register terminal 300 while interacting with a communication network (not shown).

The search request receiving unit 120 may receive a search request from the user terminal 200. The search request may include data that is input by a user via the user terminal 200. Examples of the input data may include a keyword, an image, video, wine label, sound, code, Japanese, Chinese, etc.

The search result generation unit 121 may generate a search result matching the input data. The search result may include a keyword-related advertisement corresponding to the input data included in the search request. The search result matching the input data may include at least one among an image, video, a blog, an internet café (referring to an forum service on internet), news, a book, shopping information, a map, a site, or a web document matching the input data, language data related to the input data, specific information, and question information. Here, the keyword-related advertisement refers to an advertisement that the advertiser requests to be included in a search result according to a keyword. The keyword-related advertisement may include at least one among information regarding a web site related to the advertiser who requests the keyword-related advertisement, a telephone number and location information of the advertiser, and a route code. The search service providing apparatus 100 according to an example embodiment may provide a user, who transmits a search request including a keyword that is set by an advertiser, with an advertisement corresponding to the keyword, together with a search result. Here, the advertisement corresponding to the keyword may be an advertisement registered by the advertiser.

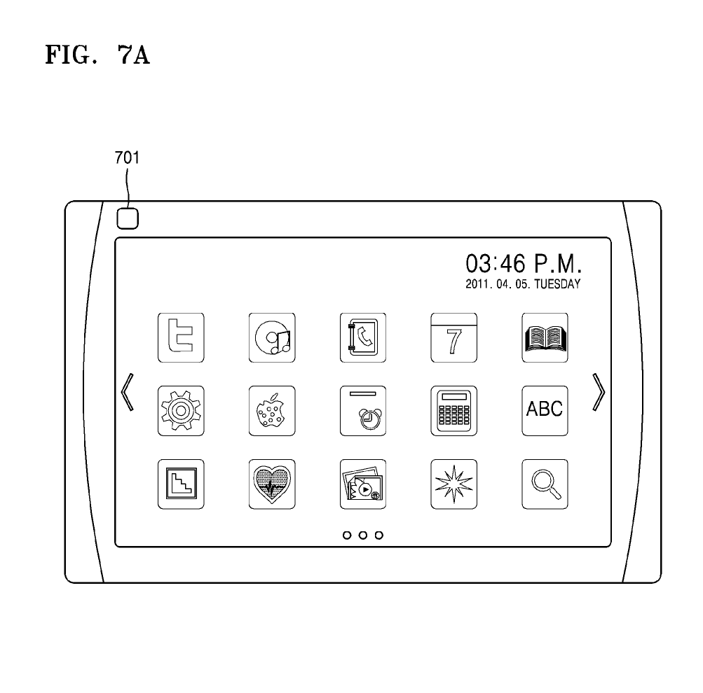

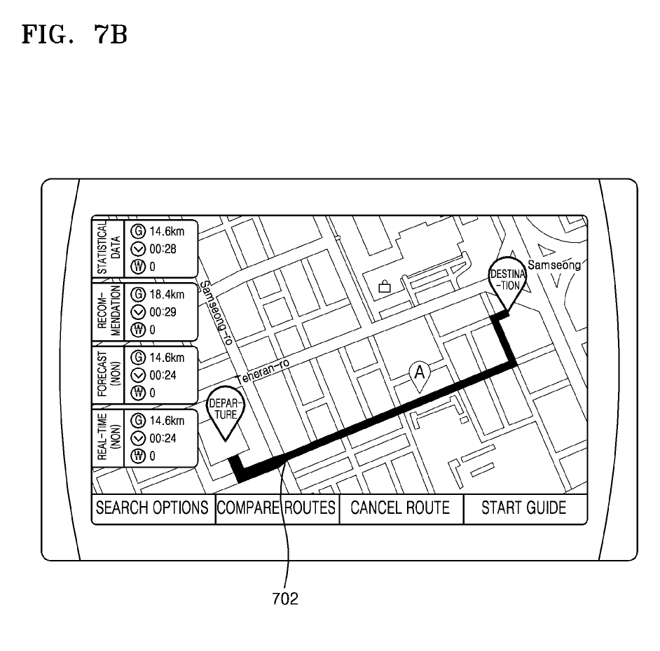

More specifically, the route code refers to a code that when executed by a processor or a computer, is set to configure the processor or the computer to provide a route to a location. An apparatus that recognizes the route code may display a route to the specific location as illustrated in FIG. 7B. As described above, data configured to parse the route code may be needed to recognize the route code and display route information corresponding to the route code. Thus, an algorithm for parsing the route code or a look-up table including the route code and data corresponding to the route code may be stored beforehand.

For example, when data input via the user terminal 200 is ‘flower shop’, the search result generation unit 121 may provide, as a search result, information regarding an advertiser ‘XX Flower’ who requests an advertisement for the input data (e.g., keyword) ‘flower shop’. In this case, the search result may include, for example, the telephone number of the shop of the advertiser ‘XX Flower’, a link to a homepage address of the advertiser ‘XX Flower’, the location of the shop, and a route code that when executed by a processor or a computer, is set to configure the processor or the computer to provide a route to the shop.

The search result transmission unit 122 may transmit the search result to the user terminal 200. The search result is provided to a user through, for example, an application or a program installed in the user terminal 200. The search result may be accessed, stored, shared, or used in various ways using the application and the program.

The event receiving unit 123 may receive, sense, monitor, or notice a user event regarding the route code included in the search result. A user may select, share, or store one of a plurality of pieces of data including the route code included in the keyword-related advertisement through a search service-related application installed in the user terminal 200. The user event regarding the route code may include at least one among selecting the route code, sharing the route code, and storing the route code. A user event corresponding to the sharing of the route code may include, for example, sharing the route code using a text message, sharing the route code through online chatting, or sharing the route code using a social network service.

The billing management unit 124 may determine a sum of money (e.g., advertisement fees) to be charged on the keyword-related advertisement, based on a user event regarding the route code. The billing management unit 124 may determine a sum of money to be charged on the advertiser of the keyword-related advertisement including the route code, based on the type of the user event regarding the route code and/or a number of times that the user event occurs. For example, since an advertisement effect is higher when the route code is shared than when the route code is selected, the billing management unit 124 may be configured to charge higher advertisement fees with respect to a user event regarding the sharing of the route code than a user event regarding the selecting of the route code.

Further, the billing management unit 124 may determine a sum of money (e.g., advertisement fees) to be charged, taking into account of the number of persons who share the route code and/or the power of influence of a medium for sharing the route code. For example, the billing management unit 124 may charge an advertiser higher advertisement fees when the route code is shared using a social network service than when route code is shared using a text message. Further, the billing management unit 124 may charge an advertiser higher advertisement fees when the route code is shared with a plurality of friends than when the route code is shared with one friend.

The advertisement request receiving unit 125 may receive, from the register terminal 300, an advertisement request to register a keyword-related advertisement so that the advertisement is searched and posted in response to a specific keyword. Here, the advertisement request may include at least one keyword for providing an advertisement, and information regarding a web site, a telephone number, a route code, and location information to be provided as a search result. In the present example embodiment, although for convenience of explanation, the register terminal 300 and the user terminal 200 have been described as different terminals. However, example embodiments are not limited thereto. The register terminal 300 and the user terminal 200 may be a same terminal.

The database 130 may store a registered keyword-related advertisement, data information corresponding to the keyword-related advertisement (e.g., a web site, a location, a route code, a telephone number, identification (ID) of a social network service, ID of an online chatting service, etc.), an advertisement fees to be charged on the keyword-related advertisement, and information regarding the advertiser. Further, the database 130 may store a route code and route information corresponding to the route code.

The search service providing apparatus 100 according to an example embodiment may enable the user terminal 200 to request a search with a route code that when executed by a processor or a computer, is set to configure the processor or the computer to provide route information, thereby saving a user's trouble in individually inputting an address, a company name, location information, etc. to search for a route to a desired location.

Further, the search service providing apparatus 100 according to an example embodiment may provide a route code that when executed by a processor or a computer, is set to configure the processor or the computer to provide a route to a location related to an advertiser who requests an advertisement based on a keyword, thereby enabling an easy access to the location related to the advertisement.

Also, the search service providing apparatus 100 according to an example embodiment may calculate or determine advertisement fees to be charged such that no fees will be charged when the route code is merely exposed and the fees will be charged when a subsequent event of selecting, sharing, or storing the route code actually occurs. That is, a register who registers an advertisement with the search service providing apparatus 100 according to an example embodiment may be charged for the advertisement fees when a subsequent event of selecting, sharing, of storing the route code is actually occurred by a user. Thus, the advertiser may obtain improved advertisement effect at the same fees.

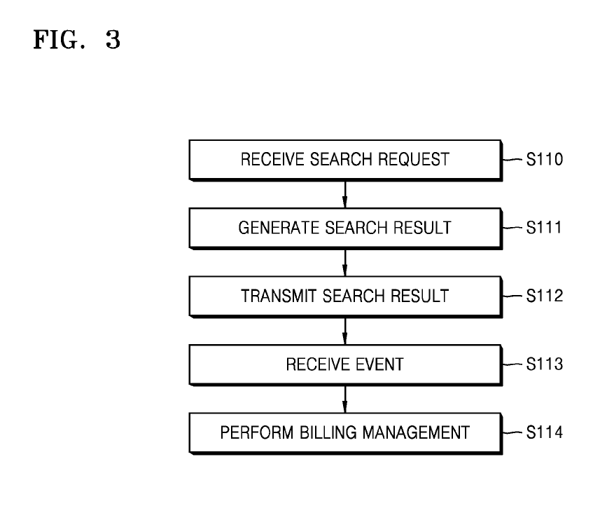

FIG. 3 is a flowchart of a search service providing method according to an example embodiment.

Referring to FIG. 3, the search service providing method according to an example embodiment may include receiving a search request (operation S110), generating a search result (operation S111), transmitting the search result (operation

S112), receiving an event (operation S113), and performing billing management (operation S114).

In receiving the search request (operation S110), a search service providing apparatus receives a search request from a user terminal. Here, the search request may include data input by a user via the user terminal. The data may include at least one among a keyword, an image, video, wine label, sound, code, Japanese, and Chinese.

In generating the search result (operation S111), the search service providing apparatus may generate a search result matching the input data. The search result matching the input data may include at least one among a keyword-related advertisement corresponding to the input data, an image, video, a blog, an internet café, news, a book, shopping information, a map, a site, or a web document that matches the input data, language data related to the input data, specific information, and question information. Here, the keyword-related advertisement refers to an advertisement that an advertiser requests to be included in a search result according to a keyword. The keyword-related advertisement may include, for example, at least one among information regarding a web site related to an advertiser who requests the keyword-related advertisement, a telephone number and location information of the advertiser, and a route code. The search service providing apparatus may further provide a user, who transmits a search request including a keyword that is set by the advertiser of the keyword-related advertisement, with the search result. The route code has been described above and thus will not be redundantly described herein below.

In transmitting the search result (operation S112), the search service providing apparatus may transmit the search result to the user terminal. The search result may be provided to a user through, for example, an application or a program installed in the user terminal. The search result may be accessed, stored, shared, or used in various ways using the application and program.

In receiving the event (operation S113), the search service providing apparatus may receive, sense, monitor, or notice a user event regarding a route code included in the keyword-related advertisement included in the search result. A user may select, share, or store one of a plurality of pieces of data including the route code included in the keyword-related advertisement through, for example, a search service-related application installed in the user terminal. The user event regarding the route code may include at least one among selecting the route code, sharing the route code, and storing the route code. A user event corresponding to the sharing of the route code may include, for example, sharing the route code using a text message, sharing the route code through online chatting, or sharing the route code using a social network service.

In performing the billing management (operation S114), the search service providing apparatus may calculate or determine advertisement fees to be charged on the keyword-related advertisement, based on the user event regarding the route code. In performing the billing management (operation S114), the search service providing apparatus may determine the advertisement fees to be charged on an advertiser of the keyword-related advertisement including the route code, based on the type of the user event regarding the route code. Calculating or determining the advertisement fees to be charged has been described above, and thus will not be redundantly described herein below.

Although not shown, the search service providing method according to an example embodiment may further include receiving an advertisement request. In receiving the advertisement request, the search service providing apparatus may receive, from a register terminal, an advertisement request to register a keyword-related advertisement so that the advertisement is searched the corresponding keyword is input by a user. The advertisement request may include at least one keyword for providing an advertisement, and information regarding a web site, a telephone number, a route code, and location information, which are to be provided as a search result.

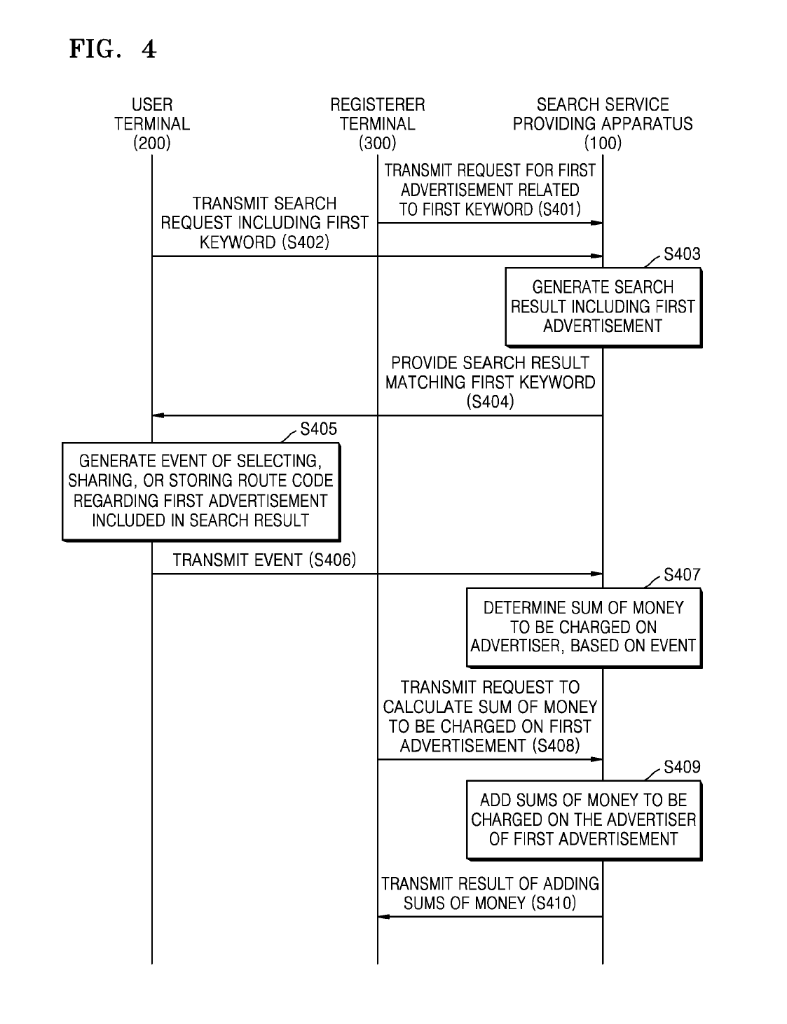

FIG. 4 is a flowchart illustrating operations of a search service providing apparatus 100, a user terminal 200, and a register terminal 300 and data exchanged among them according to one example embodiment.

As illustrated in FIG. 4, the register terminal 300 may transmit, to the search service providing apparatus 100, a request for a first advertisement to be included in a search result relating to a first keyword (operation S401). The user terminal 200 may transmit a search request including the first keyword as input data to the search service providing apparatus 100 (operation 402). The search service providing apparatus 100 may generate, as the search result related to the first keyword, a search result including the first advertisement, in response to the search request including the first keyword (operation S403), and provide the search result to the user terminal 200 (operation S404). A user may check the search result relating the first keyword via the user terminal 200, and generate (or perform) an event of selecting, sharing, or storing a route code regarding the first advertisement included in the search result (operation S405). The event may be sensed, noticed, monitored or transmitted by or to the search service providing apparatus 100 (operation S406). The search service providing apparatus 100 may determine advertisement fees to be charged on the advertiser who registers the first advertisement, based on the type of the event and/or a number of times that the event occurs (operation S407). The advertisement fees to be charged on the advertiser who registers the first advertisement to be charged may be calculated by taking into account of the types of events occurring with regard to the first advertisement and the number of times that the events occur in respective at least one user terminal 200.

The advertiser who registers the first advertisement may transmit a request to calculate the advertisement fees to be charged on the first advertisement to the search service providing apparatus 100 so as to check and pay for the fees (operation S408). For example, the search service providing apparatus 100 may calculate and add the advertisement fees to be charged on the advertiser of the first advertisement with respect to respective user terminals 200, the number of times that the events occurs, and transmit the result to the register terminal 300, in response to the request (operations S409 and S410). Further, even if no request is received from the advertiser, the search service providing apparatus 100 according to an example embodiment may transmit of the calculated advertisement fees to the advertiser of the first advertisement at desired (or alternatively, predetermined) time intervals (e.g., every one month, every one week, etc.) or in real time.

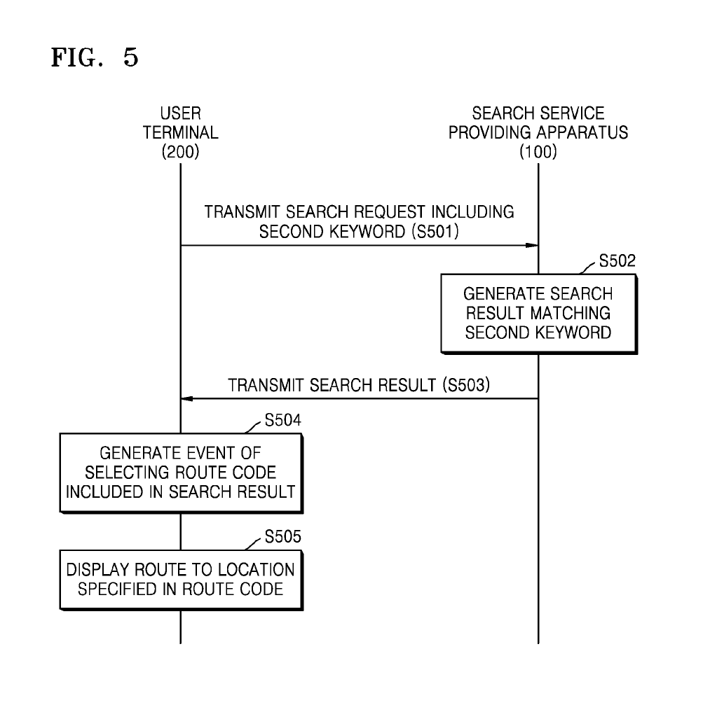

FIG. 5 is a flowchart illustrating operations of a search service providing apparatus 100 and a user terminal 200 and data exchanged among them according to another example embodiment.

The user terminal 200 may transmit a search request including a second keyword as input data to the search service providing apparatus 100 (operation S501). The search service providing apparatus 100 may generate a search result matching the second keyword (operation S502) and transmit the search result to the user terminal 200 (operation S503). The user terminal 200 may display the search result and generate an event of selecting a route code included in the search result (operation S504). When the route code is selected, the user terminal 200 may display a route to a location specified in the route code (operation S505). In order to display the route specified in the route code, a program or application including an algorithm for parsing the route code, a navigation application, or program configured to provide the route corresponding to the parsed route code may be installed in the user terminal 200.

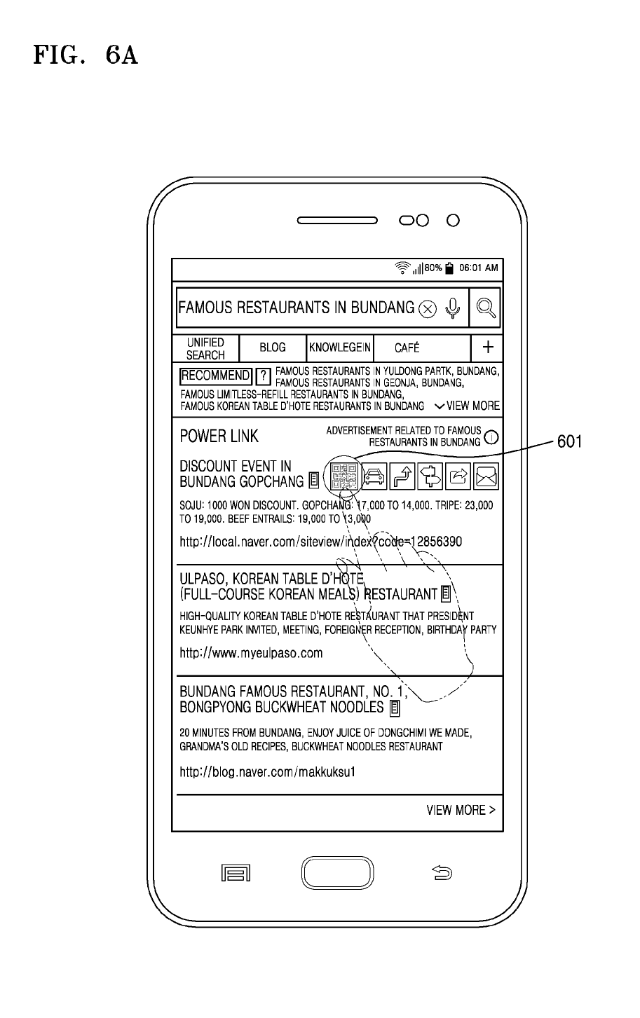

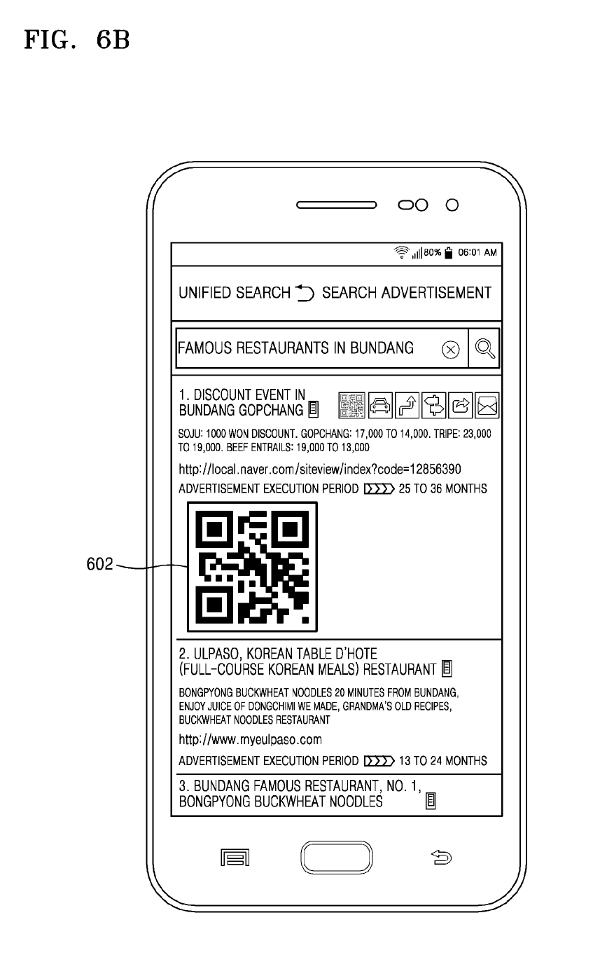

FIGS. 6A and 6B illustrate examples of a search result screen including a route code provided from the search service providing apparatus 100 of FIG. 2 according to an example embodiment.

As illustrated in FIG. 6A, the search service providing apparatus 100 may provide advertisement data regarding “XX Gopchang” as a search result regarding a search word ‘famous restaurants in Bundang’ which is input by a user. For example, the search service providing apparatus 100 may provide, as a search result, a route code 601 that is set to provide information regarding a route to “XX Gopchang”, together with the address of the web site of “XX Gopchang”. As illustrated in FIG. 6A, the search service providing apparatus 100 may expand and display the route code 602 when an event of selecting the route code 602 is input by a user.

The route code 602 provided as described above may be recognized by an external device or an element included in the user terminal 200. The external device or the user terminal 200 may provide information regarding a route to a location specified in the route code as a result of recognizing the route code 602. In some example embodiments, the external device or the user terminal 200 may set a departure position based on a user input or a location measured by a GPS module (not shown) included in the user terminal 200. The external device or the user terminal 200 may be configured to directly provide information regarding a route from the departure position to a destination specified in the route code 602 by recognizing the route code 602.

FIGS. 7A and 7B illustrate examples of a screen displayed on an apparatus that recognizes a route code provided from a search service providing apparatus 100 according to an example embodiment.

The route code 602 of FIG. 6B may be recognized by a camera 701 included in the apparatus illustrated in FIG. 7A. As illustrated in FIG. 7B, the search service providing apparatus 100 may display a route 702 to a destination as a result of recognizing the route code 602.

In a search service providing apparatus, method, and/or a computer program according to the one or more of the above example embodiments, a route code that when executed by a processor or a computer, is set to configure the processor or the computer to provide information regarding a route to a location to a user terminal. Thus, a user may directly receive information regarding a route to a specific location relating to the keyword-related advertisement through the route code, without having to individually inputting the specific location.

Further, in a search service providing apparatus, method, and/or a computer program according to the one or more of the above example embodiments, an event of selecting, sharing, or storing a route code may be separately counted and advertisement fees be charged on a register who registers the route code may be determined based on various characteristics of the user event. Thus, the register may not be charged for merely exposing the route code. Rather, the register may be charged when, for example, a user event of selecting, sharing, or storing the route code actually occurs. Thus, the advertisement fees may be differentially determined based on types or characteristics of the user event.

The above example embodiments may be embodied as a computer program executable via any computer means and recorded in a non-transitory computer-readable recording medium. The computer-readable recording medium may include a program command, a data file, and a data structure solely or in combination. Examples of the non-transitory computer-readable recording medium include magnetic media (e.g., hard disks, floppy disks, and magnetic tapes), optical media (e.g., CD-ROMs and DVDs), magneto-optical media (e.g., floptical disks), and hardware devices specifically configured to store and execute program commands (e.g., ROMs, RAMs, and flash memories). Examples of the non-transitory computer-readable recording medium may further include formless media embodied to be transmitted via a network, e.g., media that is embodied in a software or application form to be transmitted or distributed via a network.

The computer program may be designed and configured specially for the inventive concepts. Implementing such a computer program may be obvious to those of ordinary skill in the field of computer software. Examples of the computer program include not only machine language codes prepared by a compiler but also high-level codes executable by a computer by using an interpreter.

The particular implementations shown and described herein are example embodiments and are not intended to otherwise limit the scope of the inventive concepts in any way. For the sake of brevity, conventional electronics, control systems, software development and other functional aspects of the systems may not be described in detail. Furthermore, the lines or connecting elements shown in the appended drawings are intended to represent example functional relationships and/or physical or logical couplings between the various elements. It should be noted that many alternative or additional functional relationships, physical connections or logical connections may be present in a practical device. Moreover, no item or component is essential to the practice of the inventive concepts unless it is specifically described as “essential” or “critical”.

The use of the terms “a”, “an”, and “the” and similar referents in the context of describing the inventive concepts (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the operations of all methods described herein can be performed in an appropriate order unless otherwise indicated herein or otherwise clearly contradicted by context. The inventive concepts are not limited by an order in which the operations are described herein. The use of any and all examples, or example language (e.g., “such as”) provided herein, is intended merely to clearly describe the inventive concepts and does not pose a limitation on the scope of the inventive concepts unless otherwise claimed. Numerous modifications and adaptations will be readily apparent to those skilled in this art without departing from the spirit and scope of the inventive concepts.

It should be understood that example embodiments described herein should be considered in a descriptive sense only and not for purposes of limitation. Descriptions of features or aspects within each example embodiment should typically be considered as available for other similar features or aspects in other example embodiments.

While one or more example embodiments have been described with reference to the figures, it will be understood by those of ordinary skill in the art that various changes in form and details may be made therein without departing from the spirit and scope of the inventive concepts as defined by the following claims.

What is claimed is:

1. A search service providing apparatus comprising:
a memory configured to store computer-readable instructions; and
one or more processors configured to execute the instructions to,
receive a search request including input data from a user terminal, the input data including a keyword;
generate a search result in response to the input data, the search result including a keyword-related advertisement and a route code corresponding to the keyword-related advertisement;
transmit the search result to the user terminal;
monitor a user event with regard to the route code; and
determine fees to be charged on the keyword-related advertisement, based on the user event.

2. The search service providing apparatus of claim 1, wherein the route code is a code configured to provide information regarding a route to a location specified in the keyword-related advertisement.

3. The search service providing apparatus of claim 1, wherein the processor is configured to execute the instructions to determine the fees, based on at least one of a characteristic and a frequency of the user event.

4. The search service providing apparatus of claim 1, wherein the user event includes at least one of selecting the route code, sharing the route code, and storing the route code; and
the processor is configured to execute the instructions to determine the fees to be charged such that the fees incurred by the user event of selecting the route code is less than the fees incurred by the user event of sharing the route code.

5. The search service providing apparatus of claim 4, wherein the processor is configured to execute the instructions to determine the fees to be charged on the keyword-related advertisement by taking into account a number of persons with which the route code is shared according to the user event.

6. The search service providing apparatus of claim 4, wherein the user event includes an event of sharing the route code by using at least one of a text message, online chatting, and a social network service.

7. The search service providing apparatus of claim 1, wherein the processor is further configured to execute the instructions to receive, from a register terminal, an advertisement request to register the keyword-related advertisement and to have the keyword-related advertisement posted based on the search result in response to the input data including the keyword.

8. The search service providing apparatus of claim 1, wherein the route code is set to be recognized by an external device to cause the external device to display information regarding a route to a location specified in the keyword-related advertisement based on information included in the route code.

9. A method of providing a search service in a search service providing apparatus, which includes a memory configured to store computer-readable instructions and one or more processors configured to execute the instructions, the method comprising:
receiving a search request including input data from a user terminal, the input data including a keyword;
generating a search result in response to the input data, the search result including a keyword-related advertisement and route code corresponding to the keyword-related advertisement;
transmitting the search result to the user terminal;
monitoring a user event with regard to the route code; and
determining fees to be charged on the keyword-related advertisement, based on the user event.

10. The method of claim 9, wherein the route code is a code configured to provide information regarding a route to a location specified in the keyword-related advertisement.

11. The method of claim 9, wherein the determining fees includes determining the fees, based on at least one of a characteristic and a frequency of the user event.

12. The method of claim 9, wherein the user event includes at least one of selecting the route code, sharing the route code, and storing the route code; and
the determining fees includes determining the fees to be charged such that the fees incurred by the user event of selecting the route code is less than on the fees incurred by the user event of sharing the route code.

13. The method of claim 12, wherein the determining fees includes determining the fees to be charged on the keyword-related advertisement by taking into account a number of persons with which the route code is shared according to the user event.

14. The method of claim 12, wherein the user event includes an event of sharing the route code by using at least one of a text message, online chatting, and a social network service.

15. The method of claim 9, further comprising:
receiving, from a register terminal, an advertisement request to register the keyword-related advertisement and to have the keyword-related advertisement posted based on the search result in response to the input data including the keyword.

16. The method of claim 9, wherein the route code is set to be recognized by an external device to cause the external device to display information regarding a route to a location specified in the keyword-related advertisement based on information included in the route code.

17. A non-transitory computer-readable recording media storing computer-readable instructions which cause, when executed by a processor, the processor to perform the method of claim 9.
